(19) United States
(12) Patent Application Publication
(10) Pub. No.: US 2017/0097540 A1
(43) Pub. Date: Apr. 6, 2017

(54) LIQUID CRYSTAL DISPLAY APPARATUS

(71) Applicant: Samsung Display Co., Ltd., Yongin-si (KR)

(72) Inventors: Jaekook KIM, Yongin-si (KR); Seungwoon SHIN, Yongin-si (KR); Choongseob OH, Yongin-si (KR); Hyoungbin LIM, Yongin-si (KR); Yongju JEONG, Yongin-si (KR); Minsung CHOI, Yongin-si (KR)

(21) Appl. No.: 15/152,770

(22) Filed: May 12, 2016

(30) Foreign Application Priority Data
Oct. 2, 2015 (KR) 10-2015-0139107

(51) Int. Cl. G02F 1/1335

(52) U.S. Cl. CPC G02F 1/133514; G02F 1/133512; G02F 1/133509; G02F 1/133621; G02F 2001/133622

(57) ABSTRACT

A liquid crystal display apparatus includes a first substrate and a second substrate facing each other, a liquid crystal layer disposed between the first and second substrates, and a color filter layer disposed between the first substrate and the liquid crystal layer. The color filter layer includes a first color filter configured to transform incident light into light of a first color, a second color filter configured to transform incident light into light of a second color, a transparent filter configured to transmit incident light, a light-shielding unit disposed at least between the second color filter and the transparent filter, the light-shielding unit partially covering the second color filter and the transparent filter, and a compensation filter disposed between the transparent filter and the light-shielding unit, the compensation filter configured to transform incident light into blue light.

### CROSS-REFERENCE TO RELATED APPLICATION

This application claims priority from and the benefit of Korean Patent Application No. 10-2015-0139107, filed on Oct. 2, 2015, which is hereby incorporated by reference for all purposes as if fully set forth herein.

### BACKGROUND

Field

Exemplary embodiments relate to a liquid crystal display apparatus, and, more particularly, to a liquid crystal display apparatus including a compensation filter.

Discussion of the Background

As various electronic devices, such as mobile phones, personal digital assistants (PDAs), computers, large televisions (TVs) develop, demand for flat panel display devices applicable thereto may gradually increase. Among the flat panel display devices, a liquid crystal display (LCD) device has advantages of low power consumption, easy moving picture display, a high contrast ratio, etc.

An LCD device includes a liquid crystal (LC) layer disposed between two display substrates. An electric field may be applied to the LC layer to change the arrangement direction of LC molecules therein, and, thus, change the polarization direction of incident light. In this manner, an LCD device displays an image by associating the change with a polarizer and determining whether to transmit incident light for each pixel.

In an LCD device utilizing white light, color coordinates of white light emitted in a lateral direction may be shifted towards a predetermined direction with respect to color coordinates of white light emitted in a normal direction.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a liquid crystal display apparatus with reduced color shift according to viewing angles.

Additional aspects will be set forth in part in the description which follows and, in part, will be apparent from the description, or may be learned by practice of the presented embodiments.

According to an exemplary embodiment of the present invention, a liquid crystal display apparatus includes a first substrate and a second substrate facing each other, a liquid crystal layer disposed between the first and second substrates, and a color filter layer disposed between the first substrate and the liquid crystal layer. The color filter layer includes a first color filter configured to transform incident light into light of a first color, a second color filter configured to transform incident light into light of a second color, a transparent filter configured to transmit incident light, a light-shielding unit disposed at least between the second color filter and the transparent filter, the light-shielding unit partially covering the second color filter and the transparent filter, and a compensation filter disposed between the transparent filter and the light-shielding unit, the compensation filter configured to transform incident light into blue light.

According to an exemplary embodiment of the present invention, a liquid crystal display apparatus includes a first substrate including a red sub-pixel area, a green sub-pixel area, and a white sub-pixel area, a second substrate facing the first substrate, and a liquid crystal layer and a color filter layer disposed between the first and second substrates. The color filter layer includes a red color filter, a green color filter, and a transparent filter spaced apart from each other and respectively disposed in the red sub-pixel area, the green sub-pixel area, and the white sub-pixel area, a light-shielding unit disposed between the red color filter and the green color filter, and between the green color filter and the transparent filter, and a compensation filter disposed on the light-shielding unit and contacting the transparent filter, the compensation filter configured to transform incident light into blue light.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic plan view of a liquid crystal display apparatus according to an exemplary embodiment of the present invention.

FIG. 2 is a cross-sectional view taken along line II-II′ of the liquid crystal display apparatus of FIG. 1.

FIG. 3A is a conceptual view of light emitted by a liquid crystal display apparatus according to a comparative embodiment.

FIG. 3B is a conceptual view of light emitted by a liquid crystal display apparatus according to an exemplary embodiment of the present invention.

FIG. 4 is a graph of color shift according to viewing angles and correction of the color shift in a liquid crystal display apparatus according to an exemplary embodiment of the present invention.

FIG. 5 is a schematic plan view of a liquid crystal display apparatus according to an exemplary embodiment of the present invention.

FIG. 6 is a cross-sectional view taken along line VI-VI′ of the liquid crystal display apparatus of FIG. 5.

FIG. 7 is a conceptual view of a liquid crystal display apparatus including a backlight unit, according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

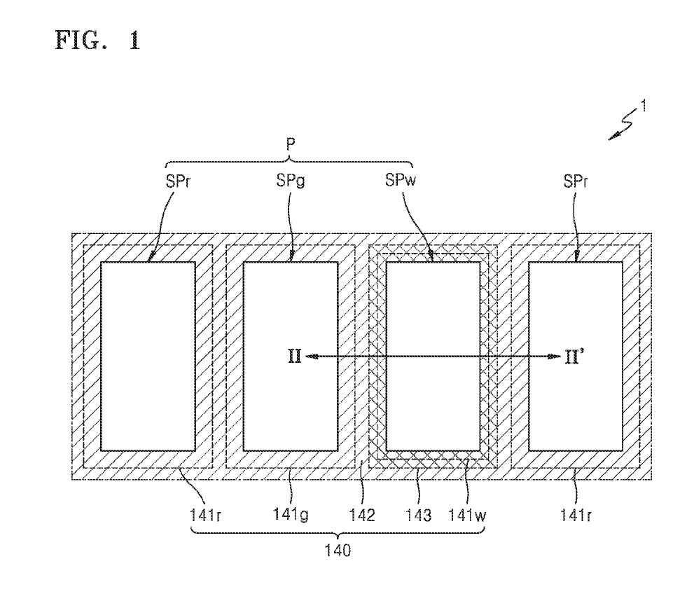

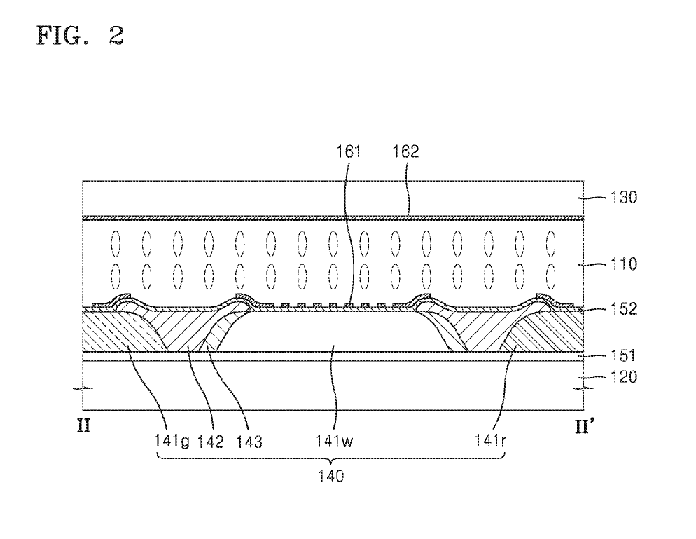

FIG. 1 is a schematic plan view of a liquid crystal display apparatus 1 according to an exemplary embodiment of the present invention. FIG. 2 is a cross-sectional view taken along line II-II′ of the liquid crystal display apparatus 1 of FIG. 1.

Referring to FIGS. 1 and 2, the liquid crystal display apparatus 1 may include a liquid crystal layer 110, a first substrate 120 and a second substrate 130 that face each other with the liquid crystal layer 110 therebetween, and a color filter layer 140 between the first substrate 120 and the liquid crystal layer 110. The color filter layer 140 may include a first color filter 141r that transforms incident light into light of a first color, a second color filter 141g that transforms the incident light into light of a second color, a transparent filter 141w that transmits the incident light without color transformation, a light-shielding unit 142 disposed between the second color filter 141g and the transparent filter 141w and partially covering the second color filter 141g and the transparent filter 141w, and a compensation filter 143 disposed between the transparent filter 141w and the light-shielding unit 142 and transforming the incident light into blue light.

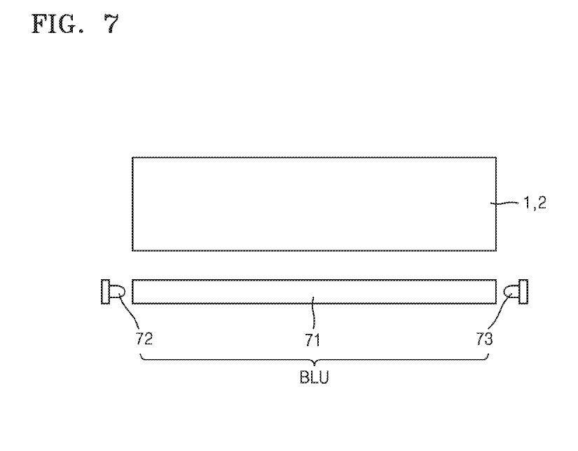

The liquid crystal display apparatus 1 displays an image according to the following processes. Light emitted by a backlight unit (BLU of FIG. 7) is incident on a first polarizer (not shown), polarized to a certain direction, and then incident on the liquid crystal layer 110. After a polarization direction is adjusted by the liquid crystal layer 110, light that passed through at least some pixels of the liquid crystal layer 110 passes through a second polarizer (not shown) and reaches a user, to display an image.

The liquid crystal display apparatus 1 may include pixels, and each of the pixels may include sub-pixels that emit light of different colors. According to an exemplary embodiment of the present invention, a pixel P in the liquid crystal display apparatus 1 may include a red sub-pixel SPr, a green sub-pixel SPg, and a white sub-pixel SPw. The pixel P may emit light of a predetermined color by selectively applying an electric field to the liquid crystal layer 110, which is arranged to correspond to the red sub-pixel SPr, the green sub-pixel SPg, and the white sub-pixel SPw.

When the electric field is applied to the entire liquid crystal layer 110 of the liquid crystal display apparatus 1, white light may be displayed due to a combination of red light, green light, and light transmitted through the white sub-pixel SPw. According to an exemplary embodiment of the present invention, the white sub-pixel SPw allows the pixel P to emit light of a predetermined color and may increase the brightness of the emitted light. The first color filter 141r, the second color filter 141g, and the transparent filter 141w may be respectively disposed on the red sub-pixel SPr, the green sub-pixel SPg, and the white sub-pixel SPw. According to an exemplary embodiment of the present invention, the first color and the second color may respectively be red and green. The first and second color filters 141r and 141g may respectively be a red color filter and a green color filter. The transparent filter 141w may be a filter that transmits light incident thereto.

The light-shielding unit 142 may be disposed between the first and second color filters 141r and 141g, between the second color filter 141g and the transparent filter 141w, and between the transparent filter 141w and the first color filter 141r. The light-shielding unit 142 may prevent mixture of colors between sub-pixels. Since light incident on a side of the light-shielding unit 142 may be absorbed by the light-shielding unit 142, a user located in a direction toward another side of the light-shielding unit 142 facing the side of the light-shielding unit 142 may not observe light that is incident on the side of the light-shielding unit 142. Although not illustrated, wiring or a driver, such as a thin-film transistor may be disposed between the first substrate 120 and the light-shielding unit 142.

According to an exemplary embodiment of the present invention, the light-shielding unit 142 may cover peripheral areas of the first color filter 141r, the second color filter 141g, and the transparent filter 141w, and surround the first color filter 141r, the second color filter 141g, and the transparent filter 141w. Areas of the first color filter 141r, the second color filter 141g, and the transparent filter 141w that are exposed through the light-shielding unit 142, i.e., the red sub-pixel SPr, the green sub-pixel SPg, and the white sub-pixel SPw, may have substantially the same size as each other.

The compensation filter 143, which transforms incident light into blue light, may be disposed between the transparent filter 141w and the light-shielding unit 142. The compensation filter 143 may be disposed between a peripheral area of the transparent filter 141w and the light-shielding unit 142, and may surround the transparent filter 141w. In this manner, an area of the transparent filter 141w covered by the light-shielding unit 142 may be smaller than areas of the first and second color filters 141r and 141g that are covered by the light-shielding unit 142, respectively, by at least an area of the compensation filter 143.

According to an exemplary embodiment of the present invention, the compensation filter 143 may contact the transparent filter 141w, but may be spaced apart from the first and second color filters 141r and 141g. The entire area of the compensation filter 143 may overlap a portion of the light-shielding unit 142 in a plan view. That is, a user located in a normal direction of the liquid crystal display apparatus 1 may not observe light that passes through the compensation filter 143 that is covered by the light-shielding unit 142.

However, a user located in a lateral direction, which is inclined by a predetermined angle with respect to the normal direction of the liquid crystal display apparatus 1, may observe light emitted from the compensation filter 143. That is, light emitted by the backlight unit (BLU of FIG. 7) may be incident on the compensation filter 143 in various directions, in which the light incident on the compensation filter 143 in the normal direction and passing through the compensation filter 143 may be blocked by the light-shielding unit 142, whereas a portion of the light incident on the compensation filter 143 in a direction inclined with respect to the normal direction may penetrate through the compensation filter 143, pass through the transparent filter 141w, and be emitted externally.

According to an exemplary embodiment of the present invention, a color shift according to viewing angles may be reduced, due to blue light that passes through the compensation filter 143 and emitted in a direction inclined with respect to the normal direction, which will be described in more detail below. According to an exemplary embodiment of the present invention, a first insulating layer 151 may be disposed between the first substrate 120 and the color filter layer 140. A second insulating layer 152 may be disposed on the color filter layer 140 and cover an upper surface of the color filter layer 140. A pixel electrode 161 and a common electrode 162 may be disposed under and/or above the liquid crystal layer 110 and apply an electric field to the liquid crystal layer 110. The electric field may be applied under the control of a driver (not shown), such as a thin-film transistor. Before the electric field is applied to the liquid crystal layer 110, an alignment layer (not shown), which determines the alignment status of the liquid crystal layer 110, may be disposed under and/or above the liquid crystal layer 110, and a pair of polarizers (not shown), which transmit only predetermined polarization components of the incident light, may be disposed under and above the liquid crystal layer 110.

It is noted that, however, the arrangement of the electrodes may be varied depending on a mode of the liquid crystal display apparatus 1. As used herein, the red light, the green light, and the blue light may refer to visible light having wavelengths of about 620 nm to about 750 nm, about 495 nm to about 570 nm, and about 430 nm to about 495 nm, respectively.

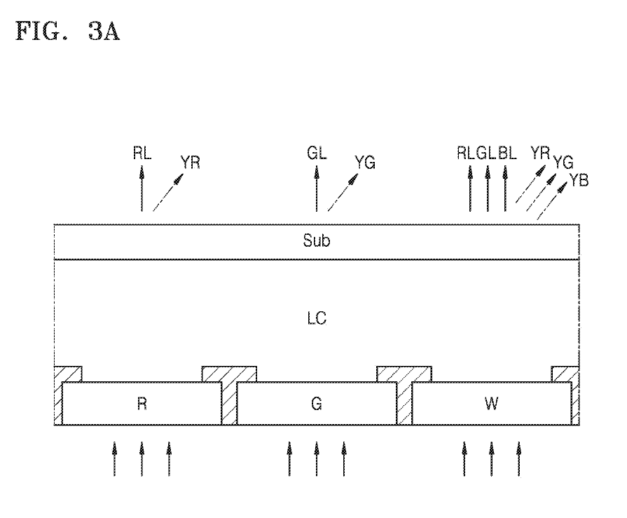

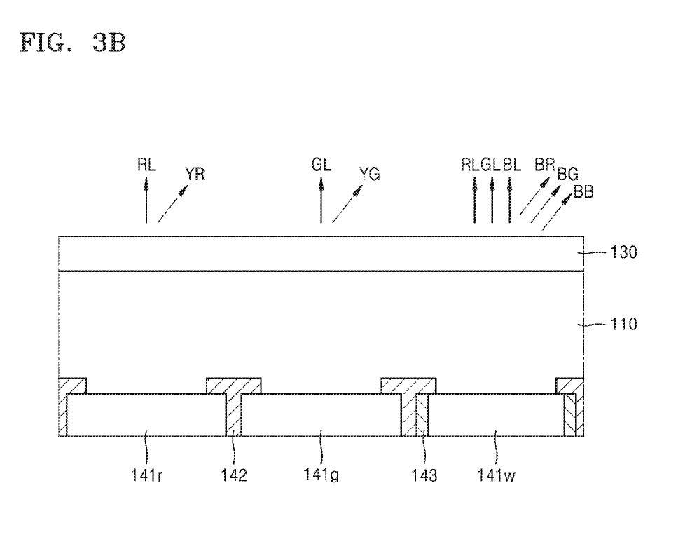

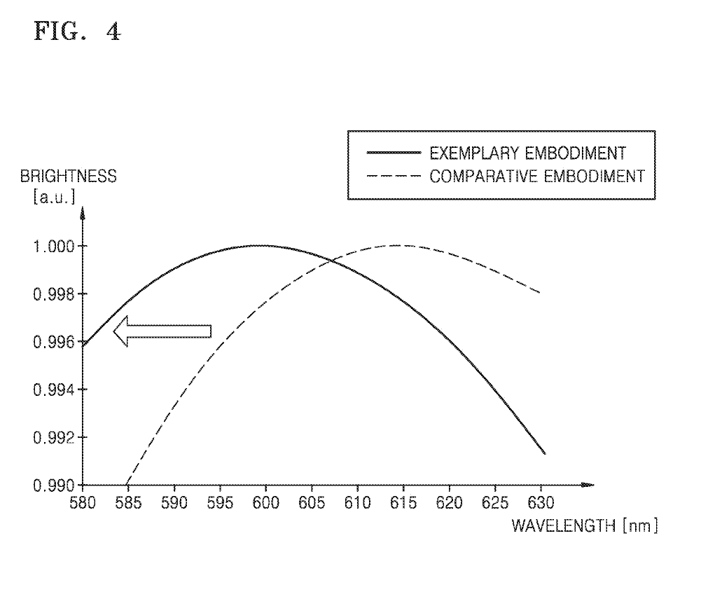

FIG. 3A is a conceptual view of light emitted by a liquid crystal display apparatus according to a comparative embodiment. FIG. 3B is a conceptual view of light emitted by a liquid crystal display apparatus according to an exemplary embodiment of the present invention. FIG. 4 is a graph of brightness according to wavelengths of light emitted at a lateral viewing angle from a liquid crystal display apparatus according to an exemplary embodiment of the present invention.

Referring to FIG. 3A, the liquid crystal display apparatus according to the comparative embodiment includes a red color filter R, a green color filter G, and a transparent filter W. Light emitted by a backlight unit (not shown), etc. may pass through the red, green, and transparent filters R, G, and W. The light that has passed through the red, green, and transparent filters R, G, and W may pass through a liquid crystal layer LC, be emitted in a direction toward a second substrate Sub, and be observed by a user.

Among light that has passed through the red color filter R and the liquid crystal layer LC and emitted externally, light emitted in a normal direction may be red light RL and light emitted in a lateral direction may be yellowish red light YR. Such color shift may occur, because an arrangement direction of the liquid crystal layer LC varies according to proceeding directions and lengths of paths of light that passes through the liquid crystal layer LC in the normal direction and light that passes through the liquid crystal layer LC in the lateral direction.

Likewise, among light that has passed through the green color filter G and the liquid crystal layer LC and emitted externally, light emitted in the normal direction may be green light GL and light emitted in the lateral direction may be yellowish green light YG. Among light that has passed through the transparent filter W and the liquid crystal layer LC and emitted externally, light emitted in the normal direction may be white light and light emitted in the lateral direction may be yellowish white light. The white light may be displayed using a combination of red light, green light, and blue light.

The transparent filter W may transmit blue light and form light of various colors by using a combination of red light and green light. Since the transparent filter W transmits all colors of light incident thereto from a backlight unit (not shown), the transparent filter W may increase the brightness of the liquid crystal display apparatus. Although the brightness of the liquid crystal display apparatus is increased by the transparent filter W, the brightness of the yellowish white light may also increase, and thus, color shift according to viewing angles may increase in the liquid crystal display apparatus.

Referring to FIG. 4, white light, which is emitted in the lateral direction in the liquid crystal display apparatus according to the comparative embodiment, may have a peak wavelength that is shifted by a predetermined value in a long wavelength direction with respect to a reference peak wavelength (i.e., about 600 nm). That is, white light is emitted in the normal direction and yellowish white light may be emitted in the lateral direction.

Referring to FIG. 3B, the liquid crystal display apparatus 1 according to an exemplary embodiment of the present invention includes a red color filter 141r, a green color filter 141g, and a transparent filter 141w. Light emitted by the backlight unit (BLU of FIG. 7) may pass through the red color, green color, and transparent filters 141r, 141g, and 141w. Light that has passed through the red color, green color, and transparent filters 141r, 141g, and 141w, may pass through the liquid crystal layer 110, emitted in a direction toward the second substrate 130, and observed by the user.

Among light that has passed through the red color filter 141r and the liquid crystal layer 110 and emitted externally, light emitted in the normal direction may be red light RL and light emitted in the lateral direction may be yellowish red light YR. Likewise, among light that has passed through the green color filter 141g and the liquid crystal layer 110 and emitted externally, light emitted in the normal direction may be green light GL and light emitted in the lateral direction may be yellowish green light YG.

The liquid crystal display apparatus 1 according to an exemplary embodiment of the present invention may include the compensation filter 143 between the light-shielding unit 142 and the transparent filter 141w. The compensation filter 143 may transform incident light into blue light. The entire area of the compensation filter 143 may overlap a portion of the light-shielding unit 142 in a plan view. In this manner, among light that has passed through the transparent filter 141w and the liquid crystal layer 110, light emitted in the normal direction may not be affected by the compensation filter 143, and, thus, be displayed as white light. However, some light proceeding in the lateral direction passes through the compensation filter 143, and, thus, light emitted in the lateral direction may be bluish white light. The bluish white light may be shown by using a combination of bluish red light BR, bluish green light BG, and blue light BB.

Light emitted in the lateral direction of the liquid crystal display apparatus 1 may be a combination of light emitted from an area where the red color filter 141r is located, light emitted from an area where the green color filter 141g is located, and light emitted from an area where the transparent filter 141w is located. As described above, the yellowish red light YR and the yellowish green light YG, which respectively passed through the red color filter 141r and the green color filter 141g and are emitted in the lateral direction, may be combined with the bluish red light BR and the bluish green light BG that pass through the transparent filter 141w and are emitted in the lateral direction.

Referring back to FIG. 4, in the liquid crystal display apparatus according to the comparative embodiment, the wavelength of the white light having a central peak wavelength of about 600 nm is shifted in a long wavelength direction. However, according to an exemplary embodiment of the present invention, the compensation filter 143 may change the shift in the long wavelength direction back in a short wavelength direction. That is, the brightness spectrum according to wavelengths of white light emitted in the normal direction may be substantially the same as the brightness spectrum according to wavelengths of white light emitted in the lateral direction, and thus, color shift according to viewing angles may be reduced.

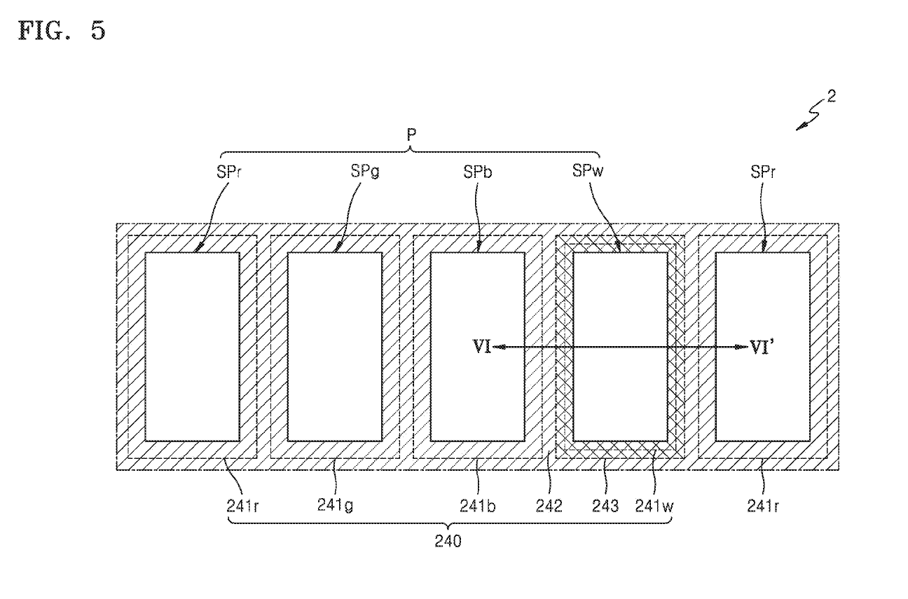

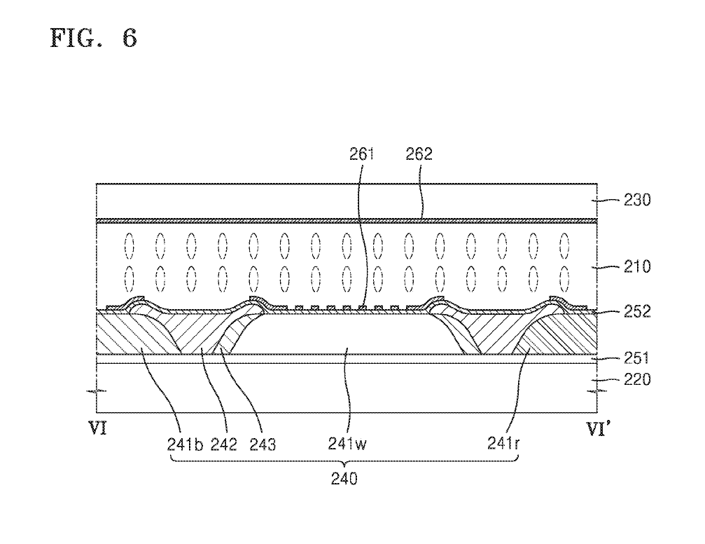

FIG. 5 is a schematic plan view of a liquid crystal display apparatus according to an exemplary embodiment of the present invention. FIG. 6 is a cross-sectional view along line VI-VI′ of the liquid crystal display apparatus of FIG. 5.

Referring to FIGS. 5 and 6, a liquid crystal display apparatus 2 according to an exemplary embodiment of the present invention may include a liquid crystal layer 210, a first substrate 220 and a second substrate 230 that face each other with the liquid crystal layer 210 therebetween, and a color filter layer 240 between the first substrate 220 and the liquid crystal layer 210. The color filter layer 240 may include a first color filter 241r that transforms incident light into light of a first color, a second color filter 241g that transforms the incident light into light of a second color, a third color filter 241b that transforms the incident light into light of a third color, a transparent filter 241w that transmits the incident light without color transformation, a light-shielding unit 242 disposed between the third color filter 241b and the transparent filter 241w and partially covering the third color filter 241b and the transparent filter 241w, and a compensation filter 243 provided between the transparent filter 241w and the light-shielding unit 242 and transforming the incident light into blue light.

The liquid crystal display apparatus 2 may include pixels, and each of the pixels may include sub-pixels that emit light of different colors. According to an exemplary embodiment of the present invention, a pixel P in the liquid crystal display apparatus 2 may include a red sub-pixel SPr, a green sub-pixel SPg, a blue sub-pixel SPb, and a white sub-pixel SPw. The pixel P may emit light of a predetermined color by selectively applying an electric field to the liquid crystal layer 110, which is arranged to correspond to the red sub-pixel SPr, the green sub-pixel SPg, the blue sub-pixel SPb, and the white sub-pixel SPw.

When the electric field is applied to the entire liquid crystal layer 210 of the liquid crystal display apparatus 2, white light may be displayed by a combination of red light, green light, blue light, and light transmitted by the white sub-pixel SPw. According to an exemplary embodiment of the present invention, the white sub-pixel SPw allows the pixel P to emit light of a predetermined color and may increase the brightness of the emitted light.

The first color filter 241r, the second color filter 241g, and the third color filter 241b, and the transparent filter 241w may be respectively disposed on the red sub-pixel SPr, the green sub-pixel SPg, and the blue sub-pixel SPb, and the white sub-pixel SPw. According to an exemplary embodiment of the present invention, the first color, the second color, and the third color may respectively be red, green, and blue. The first, second, and third color filters 241r, 241g, and 241b may respectively be a red color filter, a green color filter, and a blue color filter. The transparent filter 241w may be a filter that directly transmits light incident thereto.

The light-shielding unit 242 may be disposed between the first and second color filters 241r and 241g, between the second and third color filters 241g and 241b, between the third color filter 241b and the transparent filter 241w, and between the transparent filter 241w and the first color filter 241r. The light-shielding unit 242 may prevent mixture of colors between the sub-pixels. Since light incident on a side of the light-shielding unit 242 is absorbed by the light-shielding unit 242, a user located in a direction toward another side of the light-shielding unit 242 facing the side of the light-shielding unit 242 may not observe light that is incident on the side of the light-shielding unit 242.

According to an exemplary embodiment of the present invention, the light-shielding unit 242 may cover peripheral areas of the first color filter 241r, the second color filter 241g, the third color filter 241b, and the transparent filter 241w, and surround the first color filter 241r, the second color filter 241g, the third color filter 241b, and the transparent filter 241w. Areas of the first color filter 241r, the second color filter 241g, the third color filter 241b, and the transparent filter 241w, which are exposed through the light-shielding unit 242, i.e., areas of the red sub-pixel SPr, the green sub-pixel SPg, the blue sub-pixel SPb, and the white sub-pixel SPw, may have substantially the same size as each other.

The compensation filter 243, which transforms incident light into blue light, may be disposed between the transparent filter 241w and the light-shielding unit 242. The compensation filter 243 may be disposed between a peripheral area of the transparent filter 241w and the light-shielding unit 242, and may surround the transparent filter 241w. In this manner, an area of the transparent filter 241w covered by the light-shielding unit 242, may be smaller than areas of the first, second, and third color filters 241r, 241g, and 241b that are covered by the light-shielding unit 242, respectively, by at least an area of the compensation filter 243.

The third color filter 241b and the compensation filter 243 may include the same material. In this manner, the third color filter 241b and the compensation filter 243 may be formed simultaneously without performing an additional process for forming the compensation filter 243.

According to an exemplary embodiment of the present invention, the compensation filter 243 may contact the transparent filter 241w, but may be spaced apart from the first, second, and third color filters 241r, 241g, and 241b. The entire area of the compensation filter 243 may overlap a portion of the light-shielding unit 242 in a plan view. That is, a user located in a normal direction of the liquid crystal display apparatus 2 may not observe light that passes through the compensation filter 243 that is covered by the light-shielding unit 242.

However, a user located in a lateral direction, which is inclined by a predetermined angle with respect to the normal direction of the liquid crystal display apparatus 2, may observe light emitted from the compensation filter 243. That is, light emitted by the backlight unit (BLU of FIG. 7) may be incident on the compensation filter 243 in various directions, in which the light incident on the compensation filter 243 in the normal direction and passing through the compensation filter 243 may be blocked by the light-shielding unit 242, whereas a portion of the light incident on the compensation filter 243 in a direction inclined with respect to the normal direction may penetrate through the compensation filter 243, pass through the transparent filter 241w, and be emitted externally.

According to an exemplary embodiment of the present invention, a color shift according to viewing angles may be reduced, due to blue light that passes through the compensation filter 243 and emitted in a direction inclined with respect to the normal direction, which will be described in more detail below.

According to an exemplary embodiment of the present invention, a first insulating layer 251 may be disposed between the first substrate 220 and the color filter layer 240. A second insulating layer 252 may be disposed on the color filter layer 240 and cover an upper surface of the color filter layer 240. A pixel electrode 261 and a common electrode 262 may be disposed under and/or above the liquid crystal layer 210 and apply an electric field to the liquid crystal layer 210. The electric field may be applied under the control of a driver (not shown), such as a thin-film transistor. Before the electric field is applied to the liquid crystal layer 210, an alignment layer (not shown), which determines the alignment status of the liquid crystal layer 210, may be disposed under and/or above the liquid crystal layer 210, and a pair of polarizers (not shown), which transmit only predetermined polarization components of the incident light, may be disposed under and above the liquid crystal layer 210.

FIG. 7 is a conceptual view of a liquid crystal display apparatus including a backlight unit, according to an exemplary embodiment of the present invention.

Referring to FIG. 7, the liquid crystal display apparatus 1 or 2 according to exemplary embodiments of the present invention may further include a backlight unit BLU. The backlight unit BLU may be disposed in a direction opposite to a direction the color filter 140 or 240 is disposed on the first substrate 120 or 220, and irradiate light towards the first substrate 120 or 220.

The backlight unit BLU in the liquid crystal display apparatus 1 of FIG. 1 may include a first light source 72 and a second light source 73. The first and second light sources 72 and 73 may respectively emit blue light and yellow light.

According to an exemplary embodiment of the present invention, the first and second light sources 72 and 73 may be alternatively turned on according to a cycle of about 90 Hz. When the first light source 72 emitting blue light is turned on, the blue light may not pass through the first and second color filters 141r and 141g, but pass through the transparent filter 141w without color transformation. When the second light source 73 emitting yellow light is turned on, light that has passed through the first color filter 141r, the second color filter 141g, and the transparent filter 141w may be red light, green light, and yellow light, respectively. The yellow light may be shown by using a combination of red and green light. Since the first and second light sources 72 and 73 are alternatively turned on according to the cycle of about 90 Hz, a user may recognize yellow light and blue light as being simultaneously emitted.

In the liquid crystal display apparatus 1 of FIG. 1, the first and second light sources 72 and 73 may be alternatively turned on, and, thus, display quality and response speed of the liquid crystal display apparatus 1 may be improved.

The backlight unit BLU in the liquid crystal display apparatus 2 of FIG. 2 may include at least one of the first and second light sources 72 and 73. The first and second light sources 72 and 73 may emit white light. The white light may be transformed into red light, green light, and blue light when the white light has passed through the first, second, and third color filters 241r, 241g, and 241b, respectively. The white light may pass through the transparent filter 241w without color transformation.

The backlight unit BLU may further include a light guiding plate 71, so that light emitted from the first light source 72 and/or the second light source 73 may be uniformly irradiated to the liquid crystal display apparatus 1 or 2. The light guiding plate 71 may be disposed at one side of the liquid crystal display apparatus 1 or 2. It is noted that, however, one of the first and second light sources 72 and 73 and the light guiding plate 71 may be omitted.

As described above, the liquid crystal display apparatuses 1 and 2 according to exemplary embodiments of the present invention may provide high degree of brightness, and color shift according to viewing angles may be reduced.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A liquid crystal display apparatus, comprising:
a first substrate and a second substrate facing each other;
a liquid crystal layer disposed between the first and second substrates; and
a color filter layer disposed between the first substrate and the liquid crystal layer, the color filter layer comprising:
a first color filter configured to transform incident light into light of a first color;
a second color filter configured to transform incident light into light of a second color;
a transparent filter configured to transmit incident light;
a light-shielding unit disposed at least between the second color filter and the transparent filter, the light-shielding unit partially covering the second color filter and the transparent filter; and
a compensation filter disposed between the transparent filter and the light-shielding unit, the compensation filter configured to transform incident light into blue light.

2. The liquid crystal display apparatus of claim 1, wherein an entire area of the compensation filter overlaps at least a portion of the light-shielding unit.

3. The liquid crystal display apparatus of claim 1, wherein:
the light-shielding unit covers a peripheral area of the transparent filter and surrounds the transparent filter; and
the compensation filter is disposed between the light-shielding unit and the peripheral area of the transparent filter covered by the light-shielding unit.

4. The liquid crystal display apparatus of claim 1, wherein a portion of the transparent filter not covered by the light-shielding unit has substantially the same area as a portion the first color filter not covered by the light-shielding unit.

5. The liquid crystal display apparatus of claim 1, wherein an area of the transparent filter covered by the light-shielding unit is smaller than an area of the first color filter covered by the light-shielding unit.

6. The liquid crystal display apparatus of claim 1, wherein the compensation filter contacts the transparent filter and is spaced apart from the first color filter and the second color filter.

7. The liquid crystal display apparatus of claim 1, wherein the first color is red and the second color is green.

8. The liquid crystal display apparatus of claim 7, further comprising a backlight unit disposed on an opposite side of the first substrate than the color filter layer, the backlight unit configured to irradiate light to the first substrate,
wherein the backlight unit comprises a first light source and a second light source respectively configured to emit blue light and yellow light.

9. The liquid crystal display apparatus of claim 8, wherein the first and second light sources are configured to be alternatively turned on according to a cycle of about 90 Hz.

10. The liquid crystal display apparatus of claim 1, further comprising a third color filter disposed adjacent to at least one of the first color filter, the second color filter, and the transparent filter, the third color filter configured to transform incident light into light of a third color.

11. The liquid crystal display apparatus of claim 10, wherein:
the third color is blue; and
the compensation filter and the third color filter comprise the same material.

12. The liquid crystal display apparatus of claim 11, further comprising a backlight unit disposed on an opposite side of the first substrate than the color filter layer, the backlight unit configured to irradiate light to the first substrate,
wherein the backlight unit is configured to emit white light.

13. A liquid crystal display apparatus, comprising:
a first substrate comprising a red sub-pixel area, a green sub-pixel area, and a white sub-pixel area;
a second substrate facing the first substrate; and
a liquid crystal layer and a color filter layer disposed between the first and second substrates,
wherein the color filter layer comprises:
a red color filter, a green color filter, and a transparent filter spaced apart from each other and respectively disposed in the red sub-pixel area, the green sub-pixel area, and the white sub-pixel area;
a light-shielding unit disposed between the red color filter and the green color filter, and between the green color filter and the transparent filter; and
a compensation filter disposed on the light-shielding unit and contacting the transparent filter, the compensation filter configured to transform incident light into blue light.

14. The liquid crystal display apparatus of claim 13, wherein the color filter layer is disposed between the first substrate and the liquid crystal layer.

15. The liquid crystal display apparatus of claim 13, wherein an entire area of the compensation filter overlaps at least a portion of the light-shielding unit.

16. The liquid crystal display apparatus of claim 13, further comprising a backlight unit disposed on an opposite side of the first substrate than the color filter layer, the backlight unit configured to irradiate light to the first substrate,
wherein the backlight unit comprises a first light source and a second light source respectively configured to emit blue light and yellow light.

17. The liquid crystal display apparatus of claim 13, further comprising:
a blue sub-pixel area disposed between the green sub-pixel area and the white sub-pixel area; and
a blue color filter disposed in the blue sub-pixel area, the blue color filter comprising the same material as the compensation filter.

18. The liquid crystal display apparatus of claim 13, wherein the red sub-pixel area, the green sub-pixel area, and the white sub-pixel area have substantially same size.

19. The liquid crystal display apparatus of claim 13, wherein the compensation filter spaced apart from the red color filter and the green color filter.
